(19) United States
(12) Patent Application Publication
(10) Pub. No.: US 2013/0145101 A1
(43) Pub. Date: Jun. 6, 2013

(54) Method and Apparatus for Controlling an Operating Parameter of a Cache Based on Usage

(71) Applicant: Lisa Hsu, Kirkland, WA (US)

(72) Inventor: Lisa Hsu, Kirkland, WA (US)

(21) Appl. No.: 13/312,778

(22) Filed: Dec. 6, 2011

(51) Int. Cl. G06F 12/08; G06F 1/26

(52) U.S. Cl. 711/137; 711/118; 713/300; 711/E12.057; 711/E12.024

(57) ABSTRACT

A method and apparatus are provided for controlling power consumed by a cache. The method comprises monitoring usage of a cache and providing a cache usage signal responsive thereto. The cache usage signal may be used to vary an operating parameter of the cache. The apparatus comprises a cache usage monitor and a controller. The cache usage monitor is adapted to monitor a cache and provide a cache usage signal responsive thereto. The controller is adapted to vary the operating parameter of the cache in response to the cache usage signal.

### CROSS-REFERENCE TO RELATED APPLICATIONS

Not applicable.

### BACKGROUND

The disclosed subject matter relates generally to memory systems, and, more particularly, to reducing power consumption of a memory system.

Power consumption is an increasing issue in chip design, but one significant tradeoff to reducing power consumption is often performance. For example, in a processor that includes one or more caches, at times, it is common for the caches to be lightly used, but still fully powered so that a significant amount of leakage and dynamic current may be occurring without any resulting increase in the performance of the processor. Reducing an operating parameter of the cache, such as the supply voltage and/or clock frequency applied thereto, during these relatively idle times will reduce power consumption, but may also reduce the performance of the processor, especially if the reduced voltage and/or frequency overlaps with a period of time during which the cache is being used more intensely.

Techniques exist in which utilization of the processor core is monitored and used to modulate the supply voltage and/or clock frequencies of the processor core in a system using an Advanced Configuration and Power Interface (ACPI) standard. ACPI is a software interface where the operating system measures processor core utilization over a long period of time, and advises hardware as to the appropriate clock and power states at which it should be running. In some applications, the processor core usage is also used to control the clock frequency and/or supply voltage of the cache, as well. However, processor core utilization may not be an accurate indicator of cache usage. For example, in some circumstances, the processor core may be operating a relatively high level of usage, while the cache is not being fully utilized, or vice versa.

### BRIEF SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

One aspect of the disclosed subject matter is seen in a method that comprises monitoring usage of a cache and providing a cache usage signal responsive thereto. The cache usage signal may be used to vary an operating parameter of the cache.

Another aspect of the disclosed subject matter is seen in an apparatus comprising a cache usage monitor and a controller. The cache usage monitor is adapted to monitor a cache and provide a cache usage signal responsive thereto. The controller is adapted to vary the operating parameter of the cache in response to the cache usage signal.

### BRIEF DESCRIPTION OF THE SEVERAL VIEWS OF THE DRAWINGS

The disclosed subject matter will hereafter be described with reference to the accompanying drawings, wherein like reference numerals denote like elements, and:

FIG. 1 is a block level diagram of a computer system, including a processor interfaced with external memory;

FIG. 2 is a simplified block diagram of a dual-core module that is part of the processor of FIG. 1 and includes multiple caches and cache controls;

FIG. 3 is a block diagram of one embodiment of the cache and cache control of FIG. 2; and

FIG. 4 is a flow chart describing the operation of the cache control of FIGS. 2 and 3.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

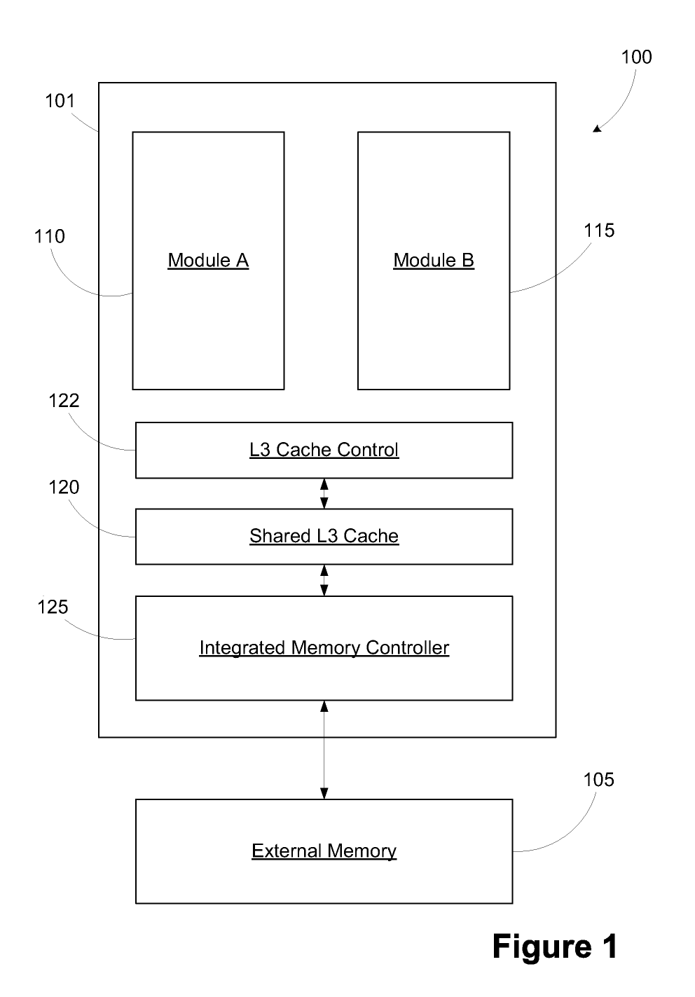

Referring now to the drawings wherein like reference numbers correspond to similar components throughout the several views and, specifically, referring to FIG. 1, the disclosed subject matter shall be described in the context of a processor system 100 comprised of a processor 101 coupled with an external memory 105. Those skilled in the art will recognize that a processor system may be constructed from these and other components. However, to avoid obfuscating the embodiments described herein, only those components useful to an understanding of the present embodiment are included.

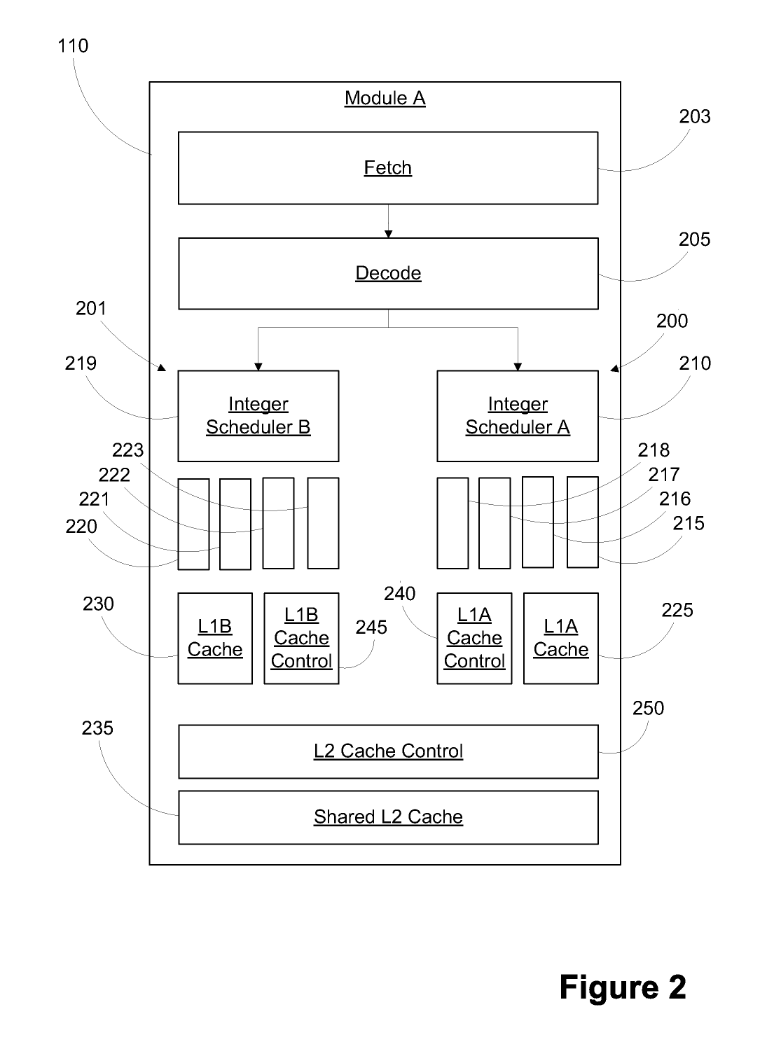

In one embodiment, the processor 101 employs a pair of substantially similar modules, module A 110 and module B 115. The modules 110, 115 are substantially similar and include processing capability (as discussed below in more detail in conjunction with FIG. 2). The modules 110, 115 engage in processing under the control of software, and thus access memory, such as external memory 105 and/or caches, such as a shared L3 cache 120 and/or internal caches (discussed in more detail below in conjunction with FIG. 2). An integrated memory controller 125 and an L3 Cache control 122 may be included within the processor 100 to manage the operation of the external memory 105 and the L3 Cache 120, respectively. The integrated memory controller 125 further operates to interface the modules 110, 115 with the conventional external semiconductor memory 105. Those skilled in the art will appreciate that each of the modules 110, 115 may include additional circuitry for performing other useful tasks.

Turning now to FIG. 2, a block diagram representing one exemplary embodiment of the internal circuitry of either of the modules 110, 115 is shown. Generally, the module 110 consists of two processor cores 200, 201 that include both individual components and shared components. For example, the module 110 includes shared fetch and decode circuitry 203, 205, as well as a shared L2 cache 235. Both of the cores 200, 201 have access to and utilize these shared components.

The processor core 200 also includes components that are exclusive to it. For example, the processor core 200 includes an integer scheduler 210, four substantially similar, parallel pipelines 215, 216, 217, 218, and an L1 Cache 225. Likewise, the processor core 201 includes an integer scheduler 219, four substantially similar, parallel instruction pipelines 220, 221, 222, 223, and an L1 Cache 230.

The operation of the module 110 involves the fetch circuitry 203 retrieving instructions from memory, and the decode circuitry 205 operating to decode the instructions so that they may be executed on one of the available pipelines 215-218, 220-223. Generally, the integer schedulers 210, 219 operate to assign the decoded instructions to the various instruction pipelines 215-218, 220-223 where they are speculatively executed. During the speculative execution of the instructions, the instruction pipelines 215-218, 220-223 may access the corresponding L1 Caches 225, 230, the shared L2 Cache 235, the shared L3 cache 120 and/or the external memory 105. Operation of the L1 Caches 225, 230 and the L2 Cache 235 may each be controlled by corresponding Cache Controls 240, 245, 250.

Those skilled in the art will appreciate that the cache controls 122, 240, 245, 250 may be implemented as completely separate devices with little or no interaction therebetween, they may be implemented as devices that share some components, or they may be implemented as a single device capable of managing the operation of all of the caches 120, 225, 230, 235.

In one embodiment, it may be useful to reduce power consumption of the processor system 100 by reducing the supply/operating voltage level of one or more of the caches 120, 225, 230, 235 when they are not being heavily accessed. For example, if Module A 110 is operating in a manner that does not generate a significant number of accesses to its L1A Cache 225, then the L1A Cache control 240 can elect to reduce the operating voltage being applied to the L1A Cache 225. Depending upon the level of the operating voltage being applied to the L1A Cache 225, the L1A Cache 225 may still be able to function, but at a slower speed than if the operating voltage were at a higher level. The reduced speed of the L1A Cache 225 may nevertheless be acceptable because the rate at which the L1A Cache 225 is being accessed is relatively low, and thus the overall operation of the processor system 100 is not significantly affected.

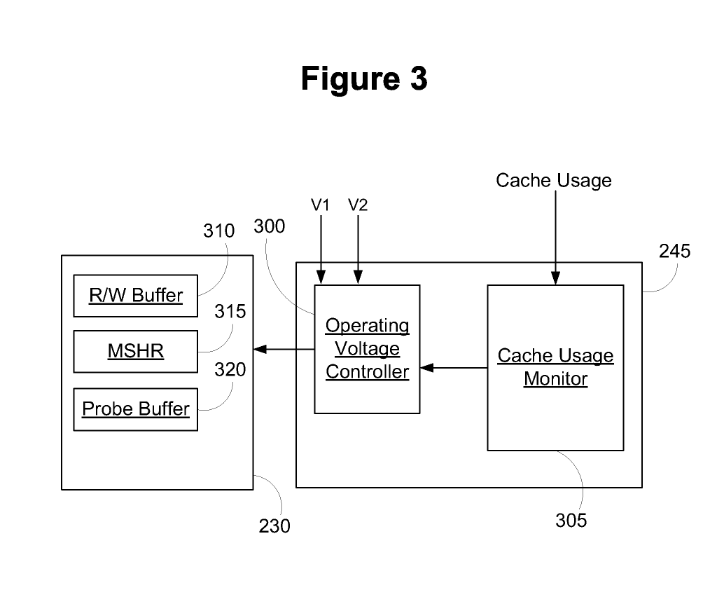

Turning now to FIG. 3, a block diagram of one embodiment of the L1B Cache Control 245 is shown. Those skilled in the art will appreciate that the structure and operation of the L1 B Cache Control 245 may be substantially similar to the structure and operation of the L1A Cache Control 240, the L2 Cache Control Control 250 and the L3 Cache Control 122.

Generally, the L1B Cache Control 245 includes an operating voltage controller 300 and a cache usage monitor 305. The Cache Usage Monitor 305 receives inputs indicative of the rate or degree at which the L1B Cache 230 is being used. When the L1B Cache 230 is used at a relatively high rate, the Cache Usage Monitor 305 responds by sending a signal to the Operating Voltage Controller 300 to apply a relatively high operating voltage V1 to the L1B Cache 230, so that the L1B Cache 230 may operate at a relatively high speed and quickly service the large usage that it is currently experiencing. Conversely, When the L1B Cache 230 is used at a relatively low rate, the Cache Usage Monitor 305 responds by sending a signal to the Operating Voltage Controller 300 to apply a relatively low operating voltage V3 to the L1B Cache 230, forcing the L1B Cache 230 to operate at a relatively low speed, which may still be adequately fast to service the small usage that the L1B Cache 230 is currently experiencing.

While the instant embodiment illustrates only two Operating Voltages V1, V2, those skilled in the art will readily appreciate that any number of Operating Voltage levels may be applied to the L1B Cache 230, depending on the level of usage detected by the Cache Usage Monitor 305. Moreover, in some applications, it may be useful to continuously vary the supply voltage relative to the cache usage, or to use some combination of a continuously variable range and discrete supply voltage levels outside of the continuously variable range.

Further, a variety of different mechanisms may be employed by the Cache Usage Monitor 305 to determine the level of usage being experienced by the L1B Cache 230. For example, one embodiment involves monitoring the number of accesses received by, or sent to, the L1B Cache 230 (such as, demand accesses, prefetches, probes, or the like), the rate at which said accesses are received by or sent to the L1B cache relative to the number of instructions completed in the associated processor core 201. For example, if a relatively large number of instructions can be completed, such as a few million instructions, without requiring an access to the L1B cache 230, then it may be surmised that the speed of operation of the L1B cache 230 is not paramount. Thus, the operating voltage for the L1B Cache 230 can be reduced to a lower level where less leakage occurs and less power is consumed.

With respect to a shared cache, such as the L2 Cache 235, it may be useful to sum the number of instructions completed by all of the processor cores 200, 201 that could generate accesses directed to the shared L2 Cache 235. The relevant factor in multiple processor or multiple processor core arrangements is that the Access per Instruction (API) value indicates how much progress the affiliated cores can make without requiring an access to the shared cache. If that time period exceeds a desired setpoint, the operating voltage level may be reduced.

Alternatively, another methodology that could be employed as an indicator of the level of usage of the L1B Cache 230 may be to monitor transaction queues associated with the L1B Cache 230. For example, the L1B Cache 230 may include read/write buffers 310, Miss Status Holding Registers (MSHRs) 315 (which hold metadata for outstanding misses to the cache 230 while they are being serviced), any structure that holds outstanding probes, such as a probe buffer 320, etc. The Cache Usage Monitor 305 may receive a signal from each of these devices regarding how full, or how many requests are pending, and this “fullness” may be used as a proxy for the level of cache usage. If the average fullness of one or more of these queues 310, 315, 320 drops below a threshold, then the decision can be made to reduce the operating voltage of the L1B cache 230. This technique would be relatively processor core agnostic and primarily judge the activity levels of the

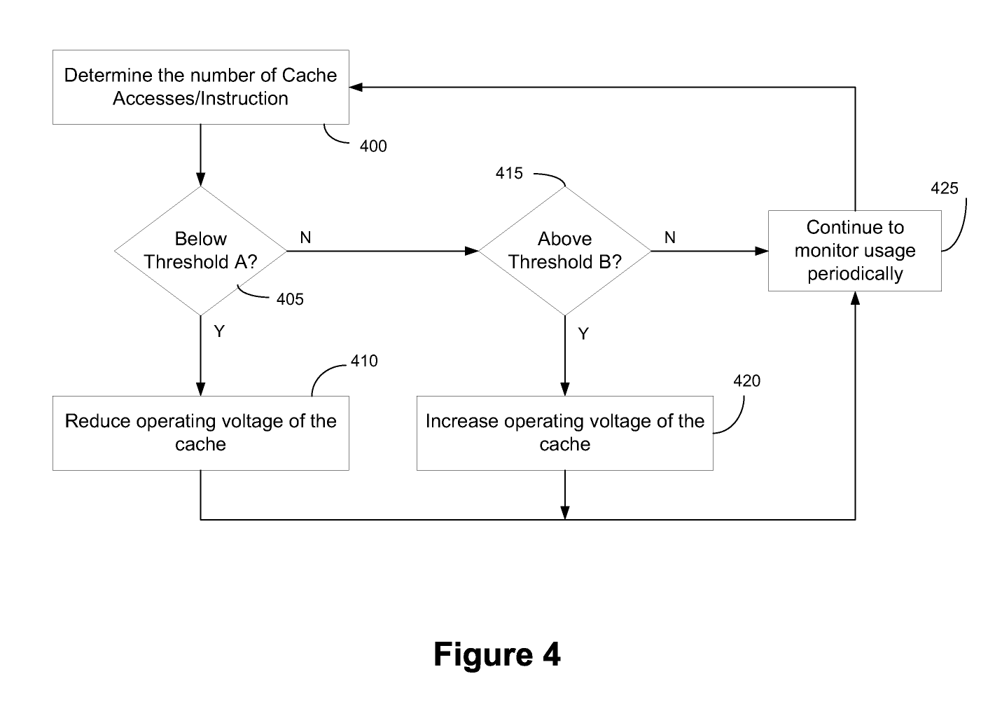

Turning now to FIG. 4, a flow chart describing one embodiment of a methodology that may be employed by the Cache Usage Monitor 305 with respect to the L1B Cache 230 is shown. The process begins at block 400 with the Cache Usage Monitor 305 determining the number of accesses to the L1B Cache 230 that occur per instruction completed by the associated processor core 201. At decision block 405, that ratio is compared to a threshold value, and if less, control transfers to block 410. At block 410, the Cache Usage Monitor 305 reduces the operating voltage level of the L1B Cache 230 to reduce power consumption by the L1B Cache 230 because it is not being heavily used.

Alternatively, if the ratio determined in block 400 is determined to be above the threshold at block 405, then control transfers to block 415. At block 415, the ratio is now compared to a threshold, and, if above, control transfers to block 420 where the Cache Usage Monitor 305 increases the operating voltage level of the L1B Cache 230 to accommodate increased usage of the L1B Cache 230. If, however, the ratio determined in block 400 is determined to be below the threshold at block 415, then control transfers to block 425 where the process is periodically repeated to accommodate changing levels of usage within the L1B Cache 230.

Those skilled in the art will readily appreciate that while the embodiments described above involve varying a supply or operating voltage of the cache, it may be useful in some applications to vary other operating parameters of the cache, such as the clock signal. For example, in some embodiments of the instant invention, it may be useful to vary the frequency, duty cycle, or the like of the clock signal delivered to the caches 120, 225, 230, 235, either separately or along with the voltage applied to each of these caches. For example, in some applications it may be useful to vary the frequency of the clock signal applied to the caches in like manner with a corresponding variation in the voltage applied to the caches. That is, reducing the frequency of the clock signal while also reducing the voltage in response to reduced usage of the caches may be useful in some applications. Likewise, increasing the frequency of the clock signal while also increasing the voltage in response to increased usage of the caches may be useful in some applications.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A method, comprising:
varying an operating parameter of a cache in response to a monitored usage of the cache.

2. A method, as set forth in claim 1, wherein varying an operating parameter of said cache further comprises varying a supply voltage applied to said cache in response to said monitored usage.

3. A method, as set forth in claim 2, wherein varying a supply voltage applied to said cache in response to said monitored usage signal further comprises applying a first supply voltage to said cache in response to the monitored usage being below a first threshold, and applying a second supply voltage to said cache in response to the monitored usage being above a second threshold, wherein said first supply voltage is less than said second supply voltage.

4. A method, as set forth in claim 2, wherein varying a supply voltage applied to said cache in response to said monitored usage further comprises continuously varying the supply voltage applied to the cache as a function of said monitored usage.

5. A method, as set forth in claim 1, wherein varying an operating parameter of said cache in response to said monitored usage further comprises varying a clock signal applied to said cache in response to said monitored usage.

6. A method, as set forth in claim 5, wherein varying a clock signal applied to said cache in response to said monitored usage further comprises varying a frequency of a clock signal applied to said cache in response to said monitored usage.

7. A method, as set forth in claim 5, wherein varying a clock signal applied to said cache in response to said monitored usage further comprises varying a duty cycle of a clock signal applied to said cache in response to said monitored usage.

8. A method, as set forth in claim 1, wherein varying the operating parameter of the cache in response to the monitored usage of the cache further comprises varying the operating parameter of the cache in response to accesses received by the cache.

9. A method, as set forth in claim 8, wherein varying the operating parameter of the cache in response to accesses received by the cache further comprises varying the operating parameter of the cache in response to a rate at which accesses are received by the cache relative to a number of instructions that are executed by an associated processor.

10. A method, as set forth in claim 1, wherein varying the operating parameter of the cache in response to the monitored usage of the cache further comprises varying the operating parameter of the cache in response to demand accesses sent to the cache.

11. A method, as set forth in claim 10, wherein varying the operating parameter of the cache in response to demand accesses sent to the cache further comprises varying the operating parameter of the cache in response to a rate at which demand accesses are sent to the cache relative to a number of instructions that are executed by an associated processor.

12. A method, as set forth in claim 1, wherein varying the operating parameter of the cache in response to the monitored usage of the cache further comprises varying the operating parameter of the cache in response to prefetches sent to the cache.

13. A method, as set forth in claim 12, wherein varying the operating parameter of the cache in response to prefetches sent to the cache further comprises varying the operating parameter of the cache in response to a rate at which prefetches are sent to the cache relative to a number of instructions that are executed by an associated processor.

14. A method, as set forth in claim 1, wherein varying the operating parameter of the cache in response to the monitored usage of the cache further comprises varying the operating parameter of the cache in response to probes sent to the cache.

15. A method, as set forth in claim 14, wherein varying the operating parameter of the cache in response to probes sent to the cache further comprises varying the operating parameter of the cache in response to a rate at which probes are sent to the cache relative to a number of instructions that are executed by an associated processor.

16. A method, as set forth in claim 1, wherein varying the operating parameter of the cache in response to the monitored usage of the cache further comprises varying the operating parameter of the cache in response to transaction queues associated with the cache.

17. An apparatus for controlling an operating parameter of a cache, comprising:
a cache usage monitor adapted to monitor a cache and provide a cache usage signal responsive to monitored usage of the cache; and
a controller adapted to receive the cache usage signal and vary the operating parameter of said cache in response to said monitored cache usage.

18. An apparatus, as set forth in claim 17, wherein the controller is further adapted to vary a supply voltage applied to said cache in response to said monitored cache usage.

19. An apparatus, as set forth in claim 18, wherein the controller is further adapted to apply a first supply voltage to said cache in response to the monitored cache usage being below a first threshold, and apply a second supply voltage to said cache in response to the monitored cache usage being above a second threshold, wherein said first supply voltage is less than said second supply voltage.

20. An apparatus, as set forth in claim 19, wherein the controller is further adapted to vary a clock signal applied to said cache in response to said monitored cache usage.

21. An apparatus, as set forth in claim 20, wherein the controller is further adapted to vary a frequency of a clock signal applied to said cache in response to said monitored cache usage.

22. An apparatus, as set forth in claim 17, wherein the cache usage monitor is further adapted to monitor accesses received by the cache.

23. An apparatus, as set forth in claim 22, wherein the cache usage monitor is further adapted to monitor a rate at which accesses are sent to the cache relative to a number of instructions that are executed by an associated processor.

24. An apparatus, as set forth in claim 17, wherein the cache usage monitor is further adapted to monitor at least one of demand accesses, probes, or prefetches sent to the cache.

25. An apparatus, as set forth in claim 24, wherein the cache usage monitor is further adapted to monitor a rate at which at least one of demand accesses, probes, or prefetches is sent to the cache relative to a number of instructions that are executed by an associated processor.

26. An apparatus, as set forth in claim 17 wherein the cache usage monitor is further adapted to monitor transaction queues associated with the cache.
